(19) United States
(12) Patent Application Publication
(10) Pub. No.: US 2005/0289232 A1
(43) Pub. Date: Dec. 29, 2005

(54) Method, apparatus, and system for monitoring performance remotely from a user

(76) Inventor: Rudiger Ebert, Adelsdorf (DE)

Correspondence Address: BRINKS HOFER GILSON & LIONE, P.O. BOX 10395, CHICAGO, IL, 60610, US

(21) Appl. No.: 11/144,308

(22) Filed: Jun. 3, 2005

Related U.S. Application Data
(60) Provisional application No. 60/577,663, filed on Jun. 7, 2004.

(30) Foreign Application Priority Data
Jun. 7, 2004 (DE) 10 2004 027 669.2

(51) Int. Cl. G06F 15/173

(52) U.S. Cl. 709/224

(57) ABSTRACT

A method, an apparatus, and a system are provided for monitoring a performance of a computer-supported system. A plurality of application units is configured to execute a task, and a service center is configured to monitor the plurality of application units. At least one monitoring unit is provided, which is communicatively coupled to the service center for data exchange and is configured to detect at least one characteristic performance variable related to the task and to send an alarm signal to the service center when the characteristic performance variable satisfies a predetermined report condition.

### RELATED APPLICATIONS

The present patent document claims the benefit of the filing date under 35 U.S.C. §119(e) of Provisional U.S. patent application Ser. No. 60/577,663, filed Jun. 6, 2004, the disclosure of which is hereby incorporated by reference.

### BACKGROUND

The present invention relates, in general, to performance monitoring of systems, and more particularly, to a method, an apparatus, and a system for monitoring a performance of a computer-supported system, in which the performance is detected remotely from a user and subjected to monitoring.

In systems and applications that are not very tolerant of waiting times for the user, such as in the medical field, the performance of the system and of the application in use may need to be monitored continuously. For instance, if the user wishes to access a patient data set that must be read in first, with the aid of further applications, then assurance is desired that the user need not wait any longer than a predetermined waiting time for the outcome of the application.

In regard to applications whose outcome or processing time depends on other processes, such as database accesses or accesses to other processes, finding out where in the system a possible bottleneck to performance is located may be a complex endeavor.

In typical systems, a service center is configured to process reports from users about poor performance of an application. However, if the user had to substantially wait for the outcome, he may have explicitly sent a specific report to the service center.

In systems that demand a substantially high reliability, such as systems in the clinical or medical field, the above-described procedure found in the prior art, which is associated with an activity on the part of the user, is typically a potential source of error.

Disadvantageously, a precondition of the above-described procedure is that any definitive worsening in performance of an application be reported to the service center. As a rule, the precondition for this service center reporting is a specific activity of the user. If this service center reporting is not done, then no measure for correcting the error can be initiated.

Moreover, the above-described procedure has the disadvantage that a slowing down or other worsening of performance cannot be identified in the foreground or on site (at the user's location).

### OBJECT AND SUMMARY

The present invention is defined by the appended claims. This description summarizes some aspects of the present embodiments and should not be used to limit the claims.

If a reliably functioning system that satisfies the end user is to be assured or made more probable, then the user-specific response time for an application is measured. If the response time exceeds a pre-determined threshold, then the system is assumed not to be functioning appropriately. As such, a corresponding report is configured to be sent automatically to the service center, without requiring intentional actions by the user.

A method for automatically recognizing an unwanted slowing down of an application or other worsening in performance of the application at the user level, that is in the foreground, is provided, and the unwanted slowing down is optionally minimized. An early warning can be attained by making changes in settings and in report conditions.

A method and an apparatus are provided for monitoring a performance of a task for execution by a computer-supported system, which includes a plurality of application units and a service center, which is configured to monitor the application units. At least one monitoring unit is provided, which is configured to detect at least one characteristic performance variable related to the task and which is in data exchange or communication with the service center, and sends an alarm signal to the service center if the characteristic performance variable meets a pre-determinable report condition.

The terms “applications task” and “task” are to be understood here as synonyms, in the sense that a task of the user accesses at least one application unit of the computer-supported system.

A reliability of the system can be substantially increased, because the performance for each application is monitored automatically and not only in response to action on the part of the user. Thus, the application performance is detected once a user launches a particular application. The monitoring may no longer be dependent on the activity of the user and is thus less vulnerable to error.

The user can decide which applications the performance will be monitored for, and which applications the monitoring will be performed for only by request, or not at all. Hence, the influence of the user is enhanced, and the user can select applications for which an automatic performance monitoring will be performed.

The pre-determinable report condition is a numerical threshold value in one embodiment. That is, as soon as the performance drops below a certain threshold, the alarm signal is sent to the service center, and optionally further steps can be initiated for improving performance.

The service center includes a plurality of units, typically with locations distributed worldwide. The service center supports a service management, because appropriate measures can be initiated as soon as worsening in performance occurs or has been reported.

The assessment variable for performance, here referred to as the characteristic performance variable, is user-specific and is defined by a response time between the sending of the task and the receiving of an outcome, or in other words, the time between when a command to execute the task is issued and when the result of the task is displayed. The performance is accordingly detected and processed remotely from and maybe out of sight of the user, so that optimal user satisfaction can be assured.

Various causes of worsening of the performance in a system may be combined so as to be handled centrally. For instance, a performance can worsen from a functional error (failed access to a database) or from an overload of a network. In both cases, which from a technical standpoint may have to do with substantially different areas and may require different mechanisms to minimize, the reduction of the effect on performance can be performed centrally or triggered or requested centrally, by activating procedures on-site.

In relatively complex systems, the applications run on-site, while data and other devices are stored in memory at some other point in the system, or centrally in a server. Often, transactions or a data exchange within the network are therefore necessary for executing an application. Moreover, processes and response times often access sub-processes and sub-process units that in terms of data technology are at a deeper level, which may require data technology transactions. Because of all these above circumstances, the waiting time of the user in an application can be estimated only with substantial difficulty and is substantially dependent on other parameters. In such systems, the provided method has the advantage that a current statement about performance is available.

A statement about performance may be derived even if there are a plurality of inter-nested processes and various data-technical layers. The characteristic performance variable may therefore be defined as the sum of the access times to all the units and processes required for the task.

To enable further flexibility, the user or the service center can define in the foreground the circumstances under which a report, in the form of an alarm signal, is to be sent to the service center. For time-critical applications, the threshold may be set low, while for less time-critical applications, the threshold can be set higher. Overall, the report condition for the characteristic performance variable can be set from one case to another and can vary from one application to another.

The provided monitoring unit is in data exchange with all, or selected ones, of the application units and optionally with further process units.

In still another embodiment, only one monitoring unit is provided for the system, and the monitoring unit and/or the service center is configured for central, user-specific monitoring of all of the application units. The monitoring unit may be distributed over a plurality of partial processes, so that not only a single central monitoring unit but instead a plurality of monitoring units are provided on-site. The monitoring unit or monitoring units may communicate the outcome of the performance measurement to the service center.

The aspect of the method that has just been described relates to measuring the performance and reporting this measurement to the service center. Another aspect of the provided method may relate to the further handling of worsening in performance.

As such, a remedy function is provided, which furnishes measures and mechanisms so that worsening in the performance can be minimized or eliminated.

The monitoring unit can access this remedy function, which for example in response to a command may take predefined measures for error correction, such as correction of worsening performance of the application unit.

The measures of the remedy function for improving the performance may be executed on-site, or in other words in the system on which the application is running or in the application environment. Additionally, the procedures for the remedy function may be executed from and administered by a central unit.

The measures of the remedy function can also run automatically or in automated fashion, or in other words without the user having to actively perform an activity (such as actively sending the service center a report about the worsening of the performance). The reliability of the system can thus be enhanced.

In still refinement, the service center may receive a message about the execution of the remedy function. As such, substantially all the measures taken may be transparent to the service center as well and can be executed for any other error correction measures.

A system for monitoring performance of a task that is executed on a computer-supported system is provided. The system has a service center that is configured for monitoring application units. At least one monitoring unit is provided, which is configured for detecting at least one characteristic performance variable with respect to the task and which is in data exchange with the service center, and may send an alarm signal to the service center if the characteristic performance variable meets a pre-determined report condition.

In client-server systems in which the transactions are of substantial significance for the reliability of the system, the system for monitoring task performances may be advantageous.

The provided method is configured for medical technology applications and for clinical systems in the field of medical technology. However, still other areas of use are also conceivable.

The provided method may also be configured as a computer program product, having a medium that is readable by a computer and having a computer program and associated program code unit; such that after the computer program has been loaded, the computer is made to perform the provided method.

A memory medium is provided, which is configured to store the above-described computer-implemented method and is readable by a computer.

### BRIEF DESCRIPTION OF THE DRAWINGS

In the following brief description of the drawings, illustrative and exemplary embodiments, which are understood not to be limiting, are described along with their characteristics and further advantages below with reference to and in conjunction with the figures.

FIG. 1 is a schematic block diagram of a monitoring apparatus.

### DETAILED DESCRIPTION OF THE DRAWINGS

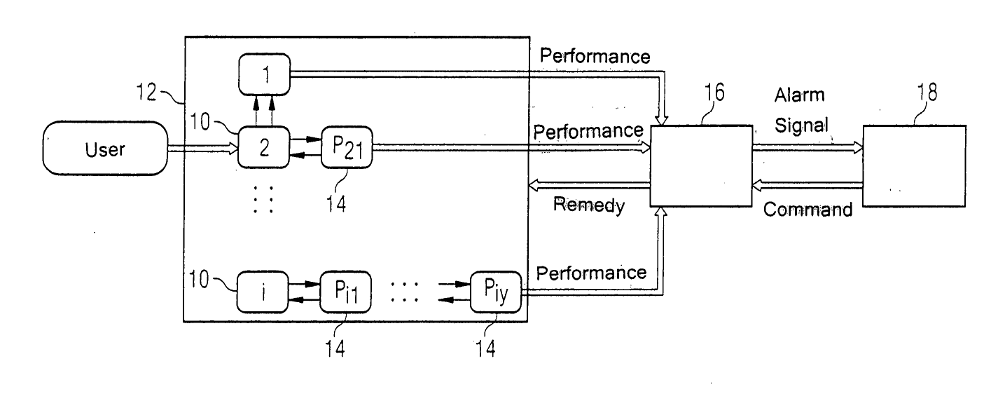

Referring to FIG. 1, a user wishes to have a task executed on a computer, such as by access to one or more application units 10. The application units 10 are interlinked along with other elements in a network, which under some circumstances may be complex, and are components of a computer-supported system 12. In medical-technology applications, the computer-supported system 12 may be interlinked worldwide.

The addressed application unit 10 may not automatically or by itself execute the application task but instead may access further process units 14 within the computer-supported system 12.

Both the application units 10 and the process units 14 may serve to perform a task for the user.

A monitoring unit 16 is also provided, which is located functionally between the application units 10 and a service center 19.

The monitoring unit 16 is configured such that for each individual task of the user and/or for each individual application unit 10 that is used for processing the task, a characteristic performance variable is detected, which may be defined by an execution time or processing time of the task or of the application or applications assigned to perform the task. Moreover, a report condition for the characteristic performance variable may be defined, of which the monitoring unit 16 is informed and which defines a threshold. When the threshold is exceeded, a corresponding report is forwarded to the service center 18.

The characteristic performance variable may be a unit of time and be defined as the response time for execution of an application remotely from the user.

Alternatively, a provision is made for defining another characteristic performance variable. The provision may include cumulatively or alternatively determined error scenarios (of the application), or other parameters that affect the satisfaction of the user.

The characteristic performance variable is defined in the monitoring unit 16. In the monitoring unit, the report condition, such as the performance report threshold, may be defined. Typically, the threshold is defined for many different applications. In an advantageous feature, various thresholds may be defined for different applications or classes of applications. This feature may enhance the flexibility of the provided method.

If the monitoring unit 16 informs the service center 18 that the performance is worsening, there may be two or more cases for proceeding further, and the user can select between them.

In a first case, the user may be instructed about the current and/or a substantially imminent worsening in performance. No further measures are taken.

In a second case, the monitoring unit 16 additionally includes a remedy function. The remedy function is configured such that at least for the substantially frequent causes of performance worsening, a catalog is provided with measures that are configured to minimize or eliminate this performance worsening. The remedy function may be launched automatically as soon as the characteristic performance variable measured drops below the threshold. Alternately, the remedy function may be configured to be launched only on the direct command of the user or of the service center 18.

Once the remedy function is activated, the user and/or the service center 18 may receive a report or notification about the remedy. This arrangement enables the remedy measures to still be capable of being executed at a later time as well and optionally for further error correction measures to be simplified.

The catalog of measures may include at least those measures that run on-site, that is, at the client or on the user terminal or the application unit 10. With the continuous measurement of performance, a substantially quick identification of where or for what reason the worsening occurred or is occurring may be established. Thus, the error correction measures of the remedy function can also be employed in a targeted way, and may be accurately targeted.

The method may be adapted optimally to the needs of the user. The performance is measured or detected remotely from the user. For the user, which application units 10 are necessary for processing his task, or which sub-processes and process units 14 are accessed, may not be informative or relevant. The performance may therefore be detected with respect to the task of the user. If a plurality of units 10, 14 are needed for performing the task, then the response times and access times are added up by the monitoring unit, so that an overall statement can be obtained about the response time for completing the task. Only that valued statement may be relevant to the user.

The performance times of the individual units 10, 14 may be detected separately, so that if needed, a statement about the performance of an application unit 10 can also be derived in order submit a report to the service center 18, for instance in response to an inquiry.

The statements about the performance of various tasks may be structured and combined in such a way that a statement about the performance of the entire system 12 can be derived.

The monitoring of the performance may be flexible, since the threshold can be varied, so that for instance for a threshold that is set fairly low substantially early warnings can be provided. As such, a report or an alarm may be forwarded, before the user even notices the worsening in performance.

The performance may be done on the level of problem-solving, or in other words in a user-specific way. The purely process-related performance may not be solely measured, but rather the performance that is visible or relevant to the user. The applications are therefore equipped with agents and appropriate interfaces, and the agents are configured for measuring transactions and transaction times.

The report condition, which when met causes an alarm signal to be sent to the service center 18, may include a plurality of portions, such as numerical limit values and other binary conditions, such as the existence of a grave error, or an exceptional state. The report condition may be distributed in the foreground inside the computer-supported system 12 and is thus available at the relevant places, for instance to the agents.

The alarm signal may include typical indications, which may allow it to identify the client within the system 12, the application units 10 or servers involved, and the type or possibly cause of the malfunction. The alarm signal may include a time stamp.

1. A method for monitoring a performance of a task for a computer-supported system, the system including a plurality of application units operable to execute the task and a service center operable to monitor the application units, the method comprising
providing at least one monitoring unit operable to communicate with the service center;
detecting at least one characteristic performance variable related to the task; and
sending an alarm signal to the service center when the at least one characteristic performance variable satisfies a pre-determined report condition.

2. The method according to claim 1, wherein the report condition is a numerical threshold value, so that the alarm signal is sent to the service center when the characteristic performance variable drops below the numerical threshold value.

3. The method according to claim 1, wherein the characteristic performance variable is related to a user and corresponds to a response time period measured between when the task is sent and an outcome is received.

4. The method according to claim 1, wherein the characteristic performance variable is determined by a sum of access times to the application units involved in the task.

5. The method according to claim 1, wherein the report condition for the characteristic performance variable is adjustable separately for each of the plurality of applications.

6. The method according to claim 1, wherein detecting the characteristic performance variable is performed automatically for each of a plurality of tasks or for at least one selected task.

7. The method according to claim 1, wherein the monitoring unit is communicatively coupled with the plurality of application units and with a plurality of process units.

8. The method according to claim 1, further comprising:
in response to a command, implementing with a remedy function a predetermined measure or measures for error correction due to a worsening of a performance of at least one of the application units.

9. The method according to claim 8, wherein the predetermined measure or measures of the remedy function are executed to improve task performance in an application environment.

10. The method according to claim 8, wherein the predetermined measure or measures of the remedy function are configured to proceed automatically, and further comprising generating a message about an execution of the remedy function.

11. The method according to claim 1, wherein the monitoring unit and the service center perform central, pre-determined user monitoring of the plurality, of application units.

12. The method according to claim 1, wherein each of the plurality of the application units, upon execution of the task, communicatively accesses at least another application units or at least one process units.

13. An apparatus for monitoring a performance of a task for a computer-supported system, the apparatus comprising:
a plurality of application units operable to execute the task;
a service center operable to monitor the plurality of application units;
at least one monitoring unit communicatively connected with the service center and operable to detect at least one characteristic performance variable related to the task and operable to send an alarm signal to the service center when the characteristic performance variable satisfies a pre-determined report condition.

14. The apparatus according to claim 13, wherein the report condition is a numerical threshold value, so that the alarm signal is sent to the service center when the characteristic performance variable drops below the numerical threshold value.

15. The apparatus according to claim 13, wherein the characteristic performance variable is user specific and is determined by a response time period between when the task is sent and when an outcome is received.

16. The apparatus according to claim 13, wherein the characteristic performance variable is determined as a sum of access times to the application units involved in the task.

17. The apparatus according to claim 13, wherein the report condition for the characteristic performance variable is adjustable for each of the plurality of application units.

18. The apparatus according to claim 13, wherein detection of the characteristic performance variable is performed automatically for each of a plurality of tasks or for at least one selected task.

19. The apparatus according to claim 13, wherein the monitoring unit is communicatively connects with each of the plurality of application units or with a predetermined set of the plurality of application units and with at least one process unit.

20. The apparatus according to claim 13, wherein the at least one monitoring unit is operable to implement a remedy function which, in response to a command, takes a predetermined measure or measures for error correction due to a worsening of the performance of at least one of the application units.

21. The apparatus according to claim 20, wherein the predetermined measure or measures of the remedy function are executed to improve task performance in an application environment.

22. The apparatus according to claim 20, wherein the predetermined measure or measures of the remedy function are operable to proceed automatically, and wherein the monitoring unit is operable to generate a message about an execution of the remedy function.

23. The apparatus according to claim 13, wherein the monitoring unit and the service center are operable for central, pre-determined user monitoring of the plurality of application units.

24. The apparatus according to claim 13, wherein each of the plurality of the application units, upon execution of the task, communicatively accesses other application units or at least one process unit.

25. A system for monitoring a performance of a computer-supported system, the system comprising:
a plurality of application units configured to execute a task;
a service center, configured to monitor the plurality of application units; and
at least one monitoring unit, which is communicatively coupled to the service center and configured to detect at least one characteristic performance variable related to the task, and to send an alarm signal to the service center when the characteristic performance variable satisfies a predetermined report condition.
